(19) United States
(12) Patent Application Publication
(10) Pub. No.: US 2012/0072944 A1
(43) Pub. Date: Mar. 22, 2012

(54) METHOD AND APPARATUS FOR PROVIDING SEAMLESS VIEWING

(75) Inventors: Michelle Felt, Randolph, NJ (US); Arvind K. Basra, Scotch Plains, NJ (US); Woo B. Lee, Basking Ridge, NJ (US)

(73) Assignees: VERIZON NEW JERSEY, Newark, NJ (US); VERIZON PATENT AND LICENSING INC., Basking Ridge, NJ (US)

(21) Appl. No.: 12/883,727

(22) Filed: Sep. 16, 2010

(51) Int. Cl. H04N 7/18; H04N 7/16

(52) U.S. Cl. 725/25; 725/85

(57) ABSTRACT

An approach is provided for presenting content seamlessly. Content is presented by one of a plurality of set-top boxes to a display for viewing by a user, wherein the plurality of set-top boxes are situated within a plurality of regions of a premise. The one set-top box is situated within one of the regions. The presentation of the content is paused in response to detection of movement of the user to another region of the premise. An inactive state is entered by the set-top box upon determining that another one of the set-top boxes is resuming the presentation of the content, wherein the other one of the set-top box corresponds to the other region.

### BACKGROUND INFORMATION

With the advent of computers, interactive electronic communications, and the Internet, as well as advances in the digital realm of consumer information, has come a reinvention of conventional entertainment and communication services to enhance programming, recording, and viewing of multimedia, such as broadcast television programs. Traditionally, broadcast media, being based on pre-computer age technology, has developed on its own path, without any regard to other media systems. With readily available, cost-effective broadband services, bandwidth intensive applications, such as audio and video streaming, have become viable mediums. Also, there has been substantial growth in the use of set-top boxes (STBs) equipped with digital video recording capabilities. Through the digital video recorder (DVR), a user may record content, such as a television program, to a memory medium so that the program may be viewed by the user at a more convenient time. The user may also be able to fast-forward or skip the unwanted sections of the program, as well as rewind to watch the program again. Further, the user may be able to set the configuration, such as weekly recording of television programs, for the DVR. Unfortunately, there is little flexibility in the way that programs can be played back on a dynamic basis to account for viewing preferences.

Therefore, there is a need for an approach that provides flexible, convenient techniques to present content seamlessly.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of presenting content seamlessly, according to an exemplary embodiment;

FIG. 2 is a diagram of a seamless viewing system deployed in a user premise, according to an exemplary embodiment;

FIG. 3 is a diagram of content processing devices (e.g., set-top box) configured to operate based on detecting the presence of a user, according to an exemplary embodiment;

FIG. 4 is a flowchart of a process for controlling presentment of content based on detecting the presence of a user, according to an exemplary embodiment;

FIGS. 5 and 6 are flowcharts of a process for presenting content seamlessly on content processing devices based on the presence of a user, according to an exemplary embodiment;

FIG. 7 is a flowchart of a process for detecting a profile of a user for controlling presentment of content to a content processing device (e.g., set-top box), according to an exemplary embodiment;

FIG. 8 is a diagram of a seamless viewing platform for managing operations of a DVR and set-top boxes within a user premise, according to an exemplary embodiment;

FIG. 9 is a diagram of a content processing device configured to operate with the seamless viewing platform of FIG. 1, according to an exemplary embodiment;

FIG. 10 is a diagram of a computer system that can be used to implement various exemplary embodiments and

FIG. 11 is a diagram of a chip set that can be used to implement various exemplary embodiments.

### DESCRIPTION OF THE PREFERRED EMBODIMENT

A preferred apparatus, method, and software for presenting content seamlessly using a digital video recorder are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to a set-top box (STB), it is contemplated that these embodiments have applicability to any device capable of processing content (e.g., audio/video (AV)) signals for presentation to a user, such as a home communication terminal (HCT), a digital home communication terminal (DHCT), a stand-alone personal video recorder (PVR), a television set, a digital video disc (DVD) player, a video-enabled phone, an audio/video-enabled personal digital assistant (PDA), and/or a personal computer (PC), as well as other like technologies and customer premises equipment (CPE).

In addition, though various exemplary embodiments are described with respect to a digital video recorder (DVR), it is contemplated that these embodiments have applicability to any device or service capable of being configured by a user to record content (e.g., audio/video (AV)) or for being rendered to a content processing device (e.g., set-top box), such as in-home recording devices, network based recording services, personal video recorders (PVR) and other like technologies.

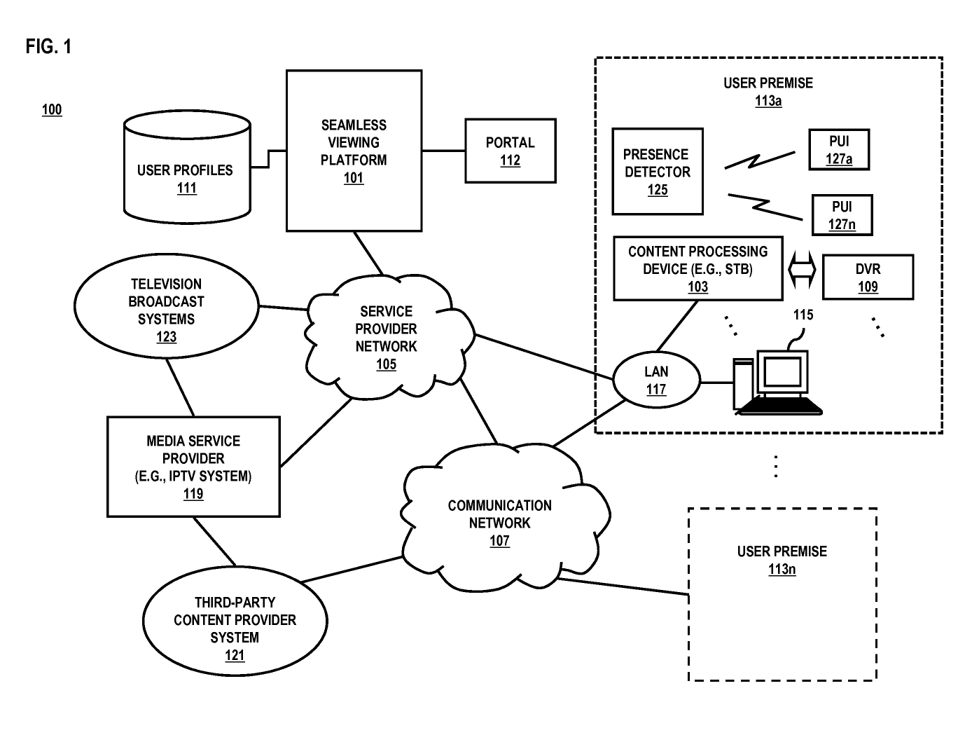

FIG. 1 is a diagram of a system capable of presenting content seamlessly, according to an exemplary embodiment. For the purposes of illustration, system 100 is described with respect to seamless viewing platform (or platform) 101 that is configured to interface with content processing devices (e.g., set-top boxes (STBs)) 103 through service provider network 105 and/or communication network 107. As used herein, a DVR or PRV device can be either a standalone DVR 109 or an integrated unit of content processing device and DVR. System 100 may be configured to support increased flexibility and efficiency in the way that content is recorded and presented. As such, users are not limited to traditional approaches to content presentment, configuring content processing device 103, or accessing recorded content. While specific reference will be made hereto, it is contemplated that system 100 may embody many forms and include multiple and/or alternative components and facilities. As will be more fully described, seamless viewing platform 101 permits content to be recorded during a period of user movement from one region of a premise to another (e.g., room-to-room). In addition, the seamless viewing platform 101 triggers automated presentment of the recorded content to another set-top box configured for another region of the premise based on detected physical presence of the user, thereby enabling a seamless viewing experience. “Seamless,” in certain embodiments, refers to an uninterrupted program, broadcast or content presentment experience to a content processing device, whereby the user experiences the same content as they travel about multiple regions of a premise 113 as they would if they remained in a single region. It is also noted that seamless viewing of content may be facilitated for off-premise coordination, such as by way of a wireless communication device configured to a communication network 107.

It is observed that television remains the prevalent global medium for entertainment and information as individuals spend a great deal of time tuning into televised media. With the introduction of the DVR, consumers are able to record content, such as televised media, to a memory medium so that the content may be accessed at a later time. Digital video recording systems offer consumers the ability to watch their favorite programs at a more convenient time by appropriately scheduling recording and later accessing of various programs for viewing. Programming or configuring the DVR can involve scheduling the recording of content based on specific broadcast times and durations, arranging a recording sequence and queue for permitting the recordation of multiple broadcasts, specifying a recurrence schedule along with specific recording features, etc. However, traditional DVR systems do not support any mechanism for dynamically coordinating the playback of multiple DVRs.

As an exemplary scenario, when viewing content displayed to a content processing device configured in one room of a premise, the user misses a portion of programming as they move to a different room. Consequently, if it takes the user one minute to reach the other room factoring in the distance or distractions they face along the way, etc., this is sufficient time to miss important programming. Assuming the user has each content processing device tuned to the same broadcast, they are able to resume viewing the content upon entry to the next room. Unfortunately, the content presented during the period of time of movement/travel by the user is lost. This is undesirable for users wishing to continuously view content while they engage in activities requiring constant movement about the premise, such as in the morning as they watch news programming while preparing and grooming for work, during a televised sport broadcast as they entertain guests, during educational programming as they travel about campus, etc. Convenience of the user is compromised when the user is required to stay in one room to avoid interruptions in the viewing of content. Likewise, user enjoyment of content is diminished as they travel between rooms with no efficient way of continuing the programming immediately where they left off; instead settling for viewing the content based on where the program is at present.

Thus, the approach of system 100, according to certain embodiments, stems from the recognition that consumers can benefit from the ability to view content in an uninterrupted fashion as they navigate from one region equipped with a content processing device (e.g., set-top box) to another. By way of this approach, the content presented to the content processing device at the moment of departure of the user from one room is made to be the starting point for presentment of the same content to the content processing device for the other room, as triggered by detecting the arrival of the user to the other room. As shown, system 100 includes seamless viewing platform 101 that may be configured to manage operations of a DVR and content processing devices within a user premise 113a. In addition, the seamless viewing platform 100 coordinates the execution of content processing devices as configured for operation in respective rooms of the user premise 113 based on the detected presence or movement of a user about the premise 113a. Operation of content processing devices 103 is executed by the seamless viewing platform 101 in connection with a presence detector 125 for recognizing and interpreting user presence and/or movement data as transmitted by one or more personalized user interfaces (PUIs) 127a-127n. The presence detector 125 in combination with PUIs 127a-127n provide means for aligning the functions of the content processing device 103 for each unique user with the control mechanisms of the seamless viewing platform 101. In this manner, system 100 allows users to continuously view content throughout the various regions of their respective user premises (e.g., 113a-113n) while automatically (or by request) accounting for the whereabouts of the user for managing the content presentment experience.

In one embodiment, the seamless viewing platform 101 is configured to maintain one or more user profiles 111 for managing the operation of respective content processing devices 103, DVR system 109 and other devices respective to a given user. Operation of content processing devices 103 for enabling seamless presentment is contingent upon proper recognition of an association between the user, the premise 113, the content processing device or a combination thereof. Therefore, the user profile 111 may include data for referencing the user relative to a device assigned uniquely to that user, including a radio-frequency identifier (RFID), an identification code, a user identifier value or other machine-readable or detectable information. Also, the user profile may include data specifying the name, address, and other contact details of the user, as well as data representative of a level of association the user has with the premise 113 or respective content processing devices 103. By way of example, the user's specified address may be referenced against the address of the user premise 113 for determining a match. As another example, the user may be assigned an access or usage level of “owner” or “guest” for indicating the extent of interaction possible between the user and the seamless viewing platform 101 in addition to various security settings and features.

In addition, the user profile 111 may also indicate various content processing device or DVR configuration preferences, content, broadcast or programming preferences and features, and other characteristics for customizing the user content display and viewing experience. In this scenario, for example, one user associated with the user premise 113 may prefer that content be presented along with captions, while another user of the same premise 113 prefers their content to be presented without captions. By way of example, DVR configuration data can relate to monitor size, audio/video interface (e.g., High-Definition Multimedia Interface (HDMI)) setup, audio settings, time zone, network address settings, etc), programming guides (e.g., available channels, blocked and hidden channels settings, skin preferences, customizations, etc.) and personal recording settings (e.g., show names, times record types (e.g., all, single, series, latest), record channels, etc.)).

It is further noted that the user profile 111 may also reference a personalized user interface (PUI) as assigned uniquely to the user. The PUI 127a-127n may be any device configured to transmit, broadcast or otherwise generate signals for identifying a unique user. In certain embodiments, this includes a key fob (Bluetooth or Wi-Fi enabled device), body metric sensor such as a weight scale, thermal or touch activated transceiver. This may also include a wireless communication device, mobile computing device, personal electronic device or other device having embedded transmitters, sensors, antennas and other signal generation or detection components. By way of example, a user's profile 111 may specify assignment of their mobile phone as a PUI 127. Under this scenario, the assigned device may transmit an identification code, a user identifier value or other machine-readable or detectable information maintained by the device (e.g., information on a subscriber identity module (SIM) card). The PUI as configured for a user may transmit its information to the presence detector 125 accordingly to enable the seamless viewing platform 101 to retrieve and send commands to the DVR 109, content processing device 103, etc. for that user.

In certain embodiments, a portal 112 interfaces with seamless viewing platform 101 to permit access by users via STBs/content processing devices 103 and/or computing device 115 (e.g., laptop, desktop, web appliance, netbook, etc.). Portal 112 provides, for example, a web-based user interface to allow users to set and update user profile information 111, DVR related settings and various features of the seamless viewing platform 101. In certain embodiments, the content processing device 103 may present the user interface directly, enabling the user to modify settings by way of a keyboard, remote control or other data entry mechanism. In the case of a remote control, seamless viewing platform 101 may be configured to allow remote control (complete or shared) of content processing device 103 and DVR 109. In further embodiments, remote control may be selectively or conditionally disabled (e.g., when content processing device 103 and DVR 109 is accessed locally or set to be controlled locally). It is noted, as discussed further with respect to various embodiments that the portal 112 may enable the rendering of a customized graphical user interface (GUI) for a specific user in relation to an established profile 111; the GUI can be presented via any type of device capable of providing a display, such as the computing device 115, for example.

Establishment of a user profile 111 may be performed upon initial setup and integration of the seamless viewing platform 101 within the user premise 113, at a later time to enable configuration updates by a user or when another STB 103 is configured for use within the user premise 113. In other instances, users may be temporarily registered or associated with the seamless viewing platform 101 as a “guest,” thereby enabling them to temporarily interact with the content processing devices, DVR, etc. based on that user's movement and presence.

By way of example, content processing device 103 and/or computing device 115 may be configured to communicate using one or more of networks 105 and 107. System 107 can include: a public data network (e.g., the Internet), various intranets, local area networks (LAN), wide area networks (WAN), the public switched telephony network (PSTN), integrated services digital networks (ISDN), other private packet switched networks or telephony networks, as well as any additional equivalent system or combination thereof. These networks may employ various access technologies including cable networks, satellite networks, subscriber television networks, digital subscriber line (DSL) networks, optical fiber networks, hybrid fiber-coax networks, worldwide interoperability for microwave access (WiMAX) networks, wireless fidelity (WiFi) networks, other wireless networks (e.g., 3G wireless broadband networks, mobile television networks, radio networks, etc.), terrestrial broadcasting networks, provider specific networks (e.g., fiber optic networks, cable networks, etc), and the like. Such networks may also utilize any suitable protocol supportive of data communications, e.g., transmission control protocol (TCP), internet protocol (IP), file transfer protocol (FTP), telnet, hypertext transfer protocol (HTTP), hypertext transfer protocol secure (HTTPS), asynchronous transfer mode (ATM), socket connections, Ethernet, frame relay, and the like, to connect content processing devices 103 to various sources of media content, such as one or more third-party content provider systems 121. Although depicted in FIG. 1 as separate networks, communication network 107 may be completely or partially contained within service provider network 105. For example, service provider network 105 may include facilities to provide for transport of packet-based communications.

According to certain embodiments, content processing devices 103 and/or computing devices 115 may be configured to communicate over one or more local area networks (LANs) corresponding to user premises 113a-113n. In this manner, routers (not shown) may be used for establishing and operating, or at least connecting to, a network such as a “home” network or LAN 117, and is used to route communications within user premises 113a-113n. For example, content processing device 103 may be a set-top box communicatively coupled to LAN 117 via a router and a coaxial cable, whereas computing devices 115 may be connected to LAN 117 via a router and a wireless connection, a network cable (e.g., Ethernet cable), and/or the like. It is noted, however, that in certain embodiments content processing device 103 may be configured to establish connectivity with LAN 117 via one or more wireless connections. Further, content processing device 103 and computing device 115 may be uniquely identified by LAN 117 via any suitable addressing scheme. For example, LAN 117 may utilize the dynamic host configuration protocol (DHCP) to dynamically assign “private” DHCP internet protocol (IP) addresses to content processing device 103 and computing devices 115, i.e., IP addresses that are accessible to devices such as devices 103 and 115 that are part of LAN 117 facilitated via router, i.e., connected to a router.

Accordingly, it is noted that user premises 113a-113n may be geospatially associated with one or more regions, one or more user profiles and one or more user accounts. As such, content processing devices 103 associated with the user premises 113a-113n may be configured to communicate with and receive information from seamless viewing platform 101. This information may include content or user profile information among many other things. Additionally, content processing devices 103 associated with the user premises 113a-113n may be configured to communicate with and receive signals and/or data streams from media service provider (MSP) 119 or other transmission facility, i.e., third-party content provider system 121. These signals may include media content retrieved over a data network (e.g., service provider network 105 and/or communication network 107), as well as conventional video broadcast content.

As used herein, media content broadly includes any audio-visual content (e.g., broadcast television programs, VOD programs, pay-per-view programs, IPTV feeds, DVD related content, etc.), pre-recorded media content, data communication services content (e.g., commercials, advertisements, videos, movies, songs, images, sounds, etc.), Internet services content (streamed audio, video, or image media), and/or any other equivalent media form. In this manner, MSP 119 may provide (in addition to their own media content) content obtained from sources, such as one or more third-party content provider systems 121, one or more television broadcast systems 123, etc., as well as content available via one or more communication networks 107, etc.

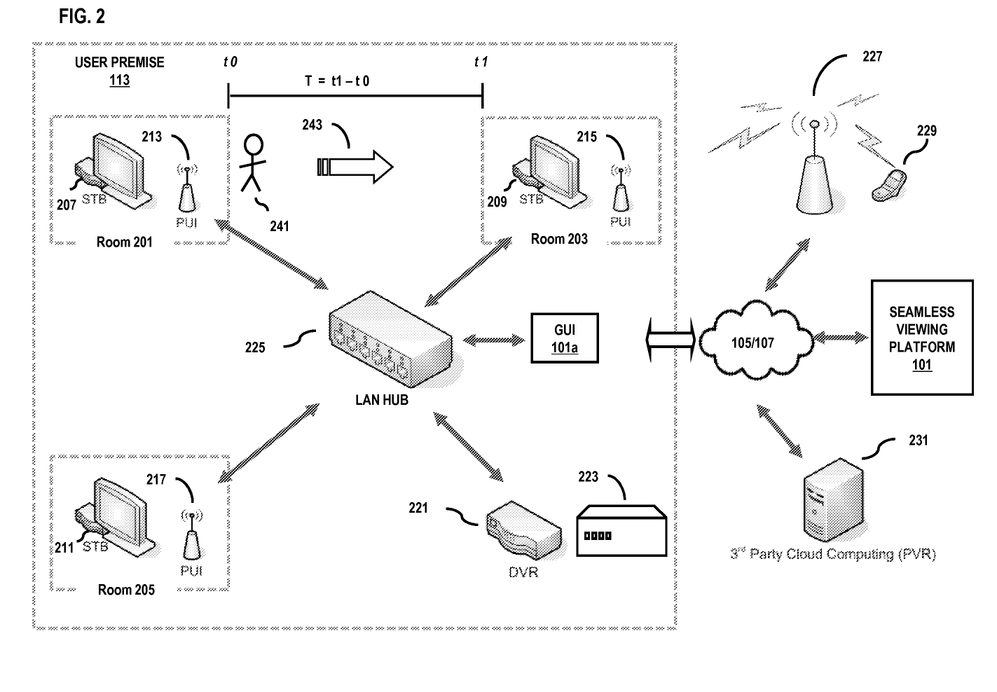

According to certain embodiments, platform 101 interacts with users through a graphical user interface ( ) associated uniquely with a user, i.e., facilitated through the portal 112. The GUI 101 aenables the customization and enhancement of a user's interaction with the various content processing devices, DVR(s) and other entertainment or media devices configured within a premise 113. In certain embodiments, the GUI 101a, illustrated by way of example in FIG. 2, is an executable module, implemented as a webservice, virtual application or the like, for generating a direct interface to the user via a set-top box 103 for which to access the various features of the platform 100. The GUI 101a may be customized by the user, feature colors, content, configurations, and other aesthetic features that readily enable users to distinguish themselves from other users as well as identify their connection to the capabilities of the seamless viewing platform 101. By accessing the GUI 101a via the portal 112, such as during the registration process, the user may align the functions of the platform 101 with the operations of their own entertainment or media devices. In certain embodiments, a single GUI 101a is assigned, arranged, established or transmitted to a particular user for directing the interactivity and connectivity of the devices. By way of example, a user's GUI 101a may be configured differently than another user's GUI 101a even when those users are within the same premise. It is noted that the user interface may be implemented as a virtual object or distributed application/object, through which data control, data access and real-time process control of the various devices within the premise 113 is facilitated. Also, it is noted that the customized graphical user interface 101a can be configured to facilitate the control mechanisms of the seamless viewing platform—i.e., enabling the platform 101 to exchange of real-time control signals or messages for manipulating the behavior of a DVR 109, set-top 103 or other devices of the user.

One function of the seamless viewing platform 101, for enabling user interactivity with the content processing devices, provides for the rendering of DVR content based on an activation signal from a presence detection mechanism. By way of example, a suitable mechanism for detecting the motion, presence, entry or exit of a user respective to a given region may include a presence detector 125 that is further configured with one or more sensor elements. The sensor elements may be placed in the same region as a respective content processing device 103, where it is configured to detect movement/presence data. In addition, the presence detector 125 may be configured to detect signals or information presented by a respective PUI 213-217 of a user. This data is provided as feedback to the seamless viewing platform 101 for enabling it to generate a signal for activating or deactivating the content processing device 103 in response to the presence or lack of presence respectively of a user within a region. It is noted that when the presence detector 125 is configured to characterize user presence and movement about a premise with PUI, it serves as a PUI engine, configured appropriately for driving the seamless viewing platform 101.

Depending on the layout of the user premise 113, as well as the number of content processing devices 103 located throughout, one or more presence detectors 125 and accompanying sensors may be enabled. Various types of sensors may be employed by the presence detector 125 for enabling it to detect the motion, presence, entry or exit of a user, including passive infrared, ultrasonic, microwave, and radio-frequency and wireless signal detection (e.g., for detecting RFID and wireless communication device signals/signatures), or combinations thereof. In certain instances, advanced sensor, image and software recognition technique may be performed by the presence detector 125 for determining user presence or movement in the absence of the particular PUI. It is further noted that in certain instances, the presence detector 125 may be a standalone unit through which multiple individual sensor elements are connected. In other instances, the sensors may be pre-installed throughout the premise 113 and linked to the content processing device for processing motion signals. In certain embodiments, the user can modify the behavior of the presence detector 125, including adjusting the sensitivity of the sensors, establishing an activation signal delay, specifying a target location within the room upon which to trigger activation of the content processing device, coordinating the interaction of multiple presence detectors 125 and sensors for tracking motion patterns and user characteristics, limiting the presence detector 125 to responding to only specific types of PUIs 213-217, etc.

Seamless viewing platform 101 can be implemented for operation with respect to a DVR device at the premise or using a 3rd party network personal video recorder (NPVR), network DVR (nDVR) or remote storage digital video recorder (RS-DVR) application/service. For such applications, the content is stored and streamed to appropriate viewing devices at a later time of recall. By way of example, the content may be streamed to the user's mobile device, such as in response to the detected exit of the user from the user premise 113 or in response to a known period of time in which the user will not have access to or be in range of a content processing device 103.

FIG. 2 is a diagram of a seamless viewing system deployed in a user premise, according to an exemplary embodiment. By way of example, the user premise 113 is comprised of multiple rooms, three of which are labeled Room 201, Room 203 and Room 205. Each of the rooms is configured with a respective content processing device 207-211. As presented with respect to FIG. 1, in certain embodiments, the content processing devices 207-211 may include a peripherally connected or integrated DVR. Alternatively, in certain embodiments, a central DVR device 221 or third party PVR 231 is configured to each set-top box 207-211 for providing content. Also, a presence detection device 223 is configured centrally or individually to each set-top box 207-211, such as by way of various sensors, for detecting the PUIs 213-217 of respective users as well as interpreting the presence or motion data they provide as feedback. Network interaction between the various devices of the user premise 113 is facilitated through a local area network (LAN) hub or multi-port connection device; the hub enabling communication with the seamless viewing platform 101 by way of a GUI 101a. As mentioned, the GUI 101a presents itself to the user as a virtual interface through which the user may align the functions of the various entertainment and media devices with the control capabilities of the seamless viewing platform 101. By way of example, the seamless viewing platform 101 generates various control messages/signals for regulating, modifying and controlling the operation of the DVR 221, set-top boxes 207-211 and other devices responsive to the activity of the user 241. Network based communication between the user and the seamless viewing platform 101 is thus enabled by a service provider or communication network 105/107.

By way of example, a user 241 whose profile is established with the seamless viewing platform 101 may travel from one room to the next throughout the premise 113 and interact with the various content processing devices 207-211 accordingly. When user 241 exits Room 201 at a time t0, proceeds in direction 243, then enters Room 203 at a time t1, the duration of time elapsed is represented as T=t1−t0, also referred to herein as an overlap period. During elapsed time T, in accordance with certain embodiments, the seamless viewing platform 101 generates a control signal specifying that DVR 221 or optionally a network based recording service (e.g., PVR 231) record the content presented by content processing device 207 starting at the point of departure (time=t0) of the user 241 from Room 201. In addition, the seamless viewing platform 101 generates a control signal instructing the DVR 221 to enable replay of the recorded content at time tl, corresponding to the moment of entry of the user to Room 203.

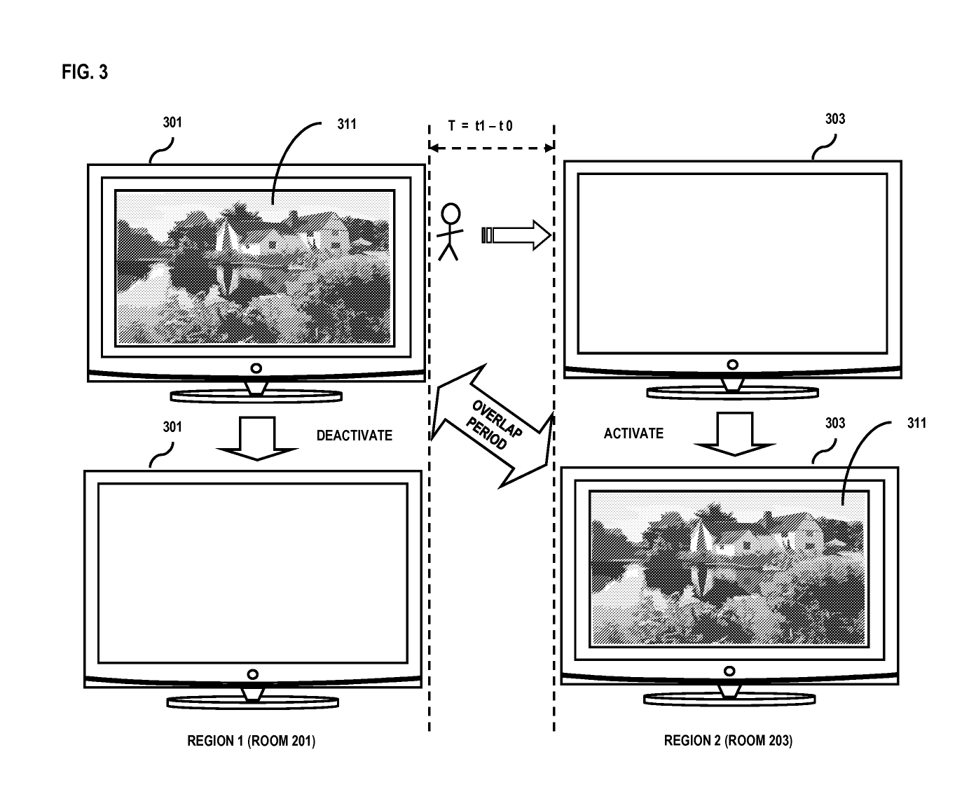

FIG. 3 is a diagram of content processing devices (e.g., set-top box) configured to operate based on detecting the presence of a user, according to an exemplary embodiment. By way of example, the behavior of the content processing device 301 before and after departure of user 241 from Room 201 is depicted. Likewise, the behavior of the content processing device 303 before and after entry of the user 241 to Room 203 is depicted. Time period T representing the elapsed time between detection of the presence of user 241 also corresponds to an overlap period. In certain embodiments, the overlap period is a moment during which the content processing device 301 of Room 201 and the content processing device 303 of Room 203 concurrently present the content. When the user exits Room 201, the content processing device 301 (e.g., set-top box) actively presents content 311. Upon entry to Room 203, corresponding to the end of the overlap period, the seamless viewing platform 101 generates a control signal specifying activation of set-top box 303 for presentation of the content 311, while set-top box 301 is deactivated upon expiration of the overlap period. It is noted, therefore, that the behavior of respective content processing devices 301 and 303 is adapted by the seamless viewing platform 101 in response to the movement of the user 241.

For illustrative purposes, in FIG. 2, should the user 241 leave the user premise 113 upon exit from Room 201 at time t0, the seamless viewing platform 101 can generate a control signal for prompting the DVR 221 to present recorded content to the user's 241 wireless communication device 229 (e.g., Smartphone, mobile phone). The content will be presented to the wireless communication device 229 with a starting point of presentment corresponding to the content at time=t0. As the user is off the premise, detection of the whereabouts, movement or location of the user 241 can be facilitated by the wireless carrier or through various location detection services implemented by the wireless communication device. Various approaches for detecting the presence of the user outside of the user premise 113 by way of their wireless communication device 229 may include detecting spatio-temporal data alterations, global positioning data tracking, triangulation, cell tower approximation, etc, as performed via satellite or cellular tower 227. It is noted, therefore, that the wireless communication device 229 operates as a PUI in this case, enabling the transmission of identification data pertinent to the user (by way of the wireless communication device) to the seamless viewing platform 101.

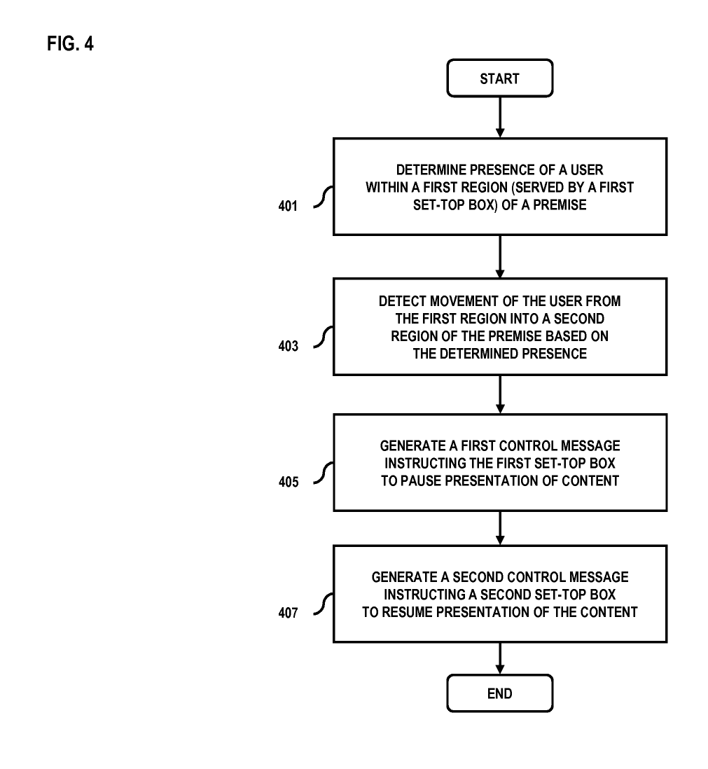

FIG. 4 is a flowchart of a process for controlling presentment of content based on detecting the presence of a user, according to an exemplary embodiment. For the purpose of illustration, the processes are described with respect to FIG. 1. It is noted that the steps of the process may be performed in any suitable order, as well as combined or separated in any suitable manner. In step 401, the presence detector 125 determines the presence and/or identity of a user within a first region of a premise, such as by way of a device configured to act as a PUI. The region is configured with a first set-top box for presenting content to a user. In step 403, the presence detector 125 detects the movement of the user from the first region to a second region of the premise. As previously mentioned, the presence detector 125 employs one or more sensors (e.g., sensor arrays) that are placed about the premise—i.e., within proximity of a set-top box or throughout a given region—for detecting variations in the movement or presence of a user. Feedback (e.g., sense data) regarding the movement, presence or activity of the user is also presented to the seamless viewing platform 101.

Once movement is detected by the user, the seamless viewing platform 101 generates a first control message instructing the first set-top box to pause presentation of content, per step 405. In step 407, the seamless viewing platform 101 generates a second control message instructing a second set-top box to resume presentation of the content. As mentioned, this operation accounts for an overlap period during which the content on the first and second set-top boxes is presented concurrently (made to enable the programming to resume on the second set-top box where the first set-top box left off). It is noted that the process of pausing presentation of content may also correspond to activating the DVR for enabling recording content. In this manner, when it is detected that the user has exited a region of the premise, the content that would typically be missed by the user as they travel to another region of the premise is captured. The process of resuming presentation of the content, therefore, ensures presentment of the content at the point at which the user left off in the first region.

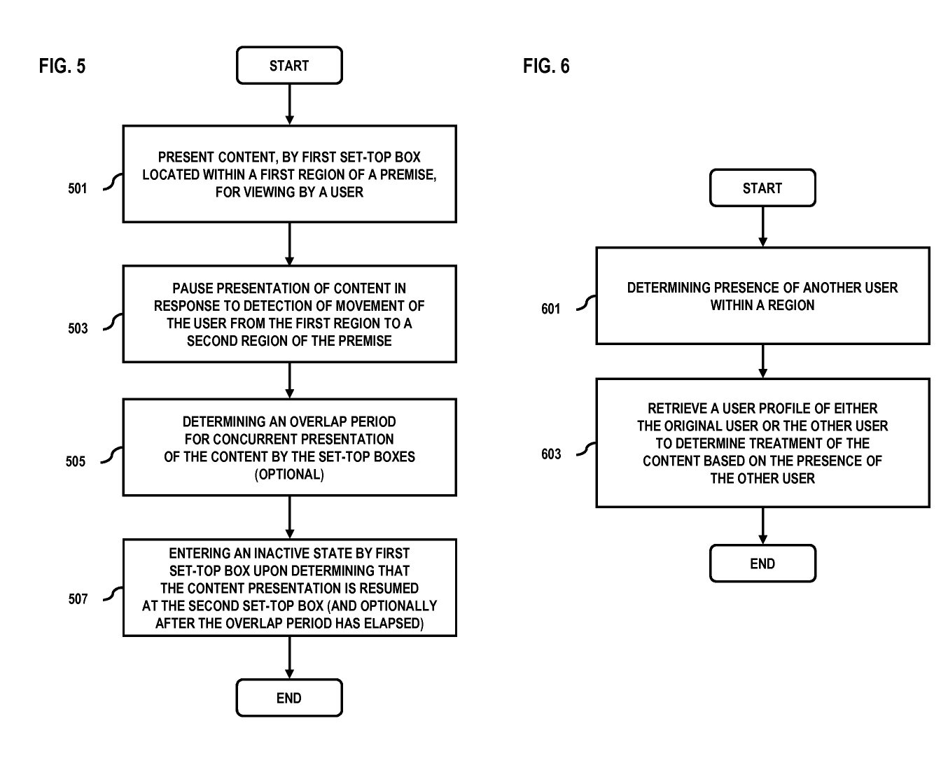

FIGS. 5 and 6 are flowcharts of a process for presenting content seamlessly on content processing devices based on the presence of a user, according to an exemplary embodiment. For the purpose of illustration, the processes are described with respect to FIG. 1. It is noted that the steps of the processes may be performed in any suitable order, as well as combined or separated in any suitable manner. In step 501, a first set-top located within a first region (e.g., room) of a premise presents content for viewing by a user. In response to detection of movement of the user from the first region, where content is currently being displayed, to a second region, presentation of the content is paused, per step 503. Optionally, as the user moves from the first region to the second, an overlap period may be determined for enabling concurrent presentation of the content on respective set-top boxes, corresponding to step 505. In step 507, the first set-top box enters an inactive state upon determining that the content presentation is resumed at the second set-top box; also corresponding to elapse of the overlap period.

It is noted that multiple users may occupy a premise at a given time. In certain embodiments, the users establish individual profiles 111 for enabling their interaction with the various set-top boxes of the premise through use of the seamless viewing platform 101. Resultantly, the users may establish individual PUIs for interfacing with the platform 101. For the purpose of illustration, the exemplary process for enabling multiple user interaction is described with respect to FIG. 1. In step 601 of FIG. 6, the presence detector 125 by way of one or more sensors, detects the presence of another user within a region. In step 603, the seamless viewing platform 101 retrieves a user profile 111 of either the original user or the other user to determine the treatment of the content based on the presence of the other user. As mentioned previously, this may include a determination as to whether or not to enable the presentment of content to the other user based on their profile settings, permissions, etc. In other instances, the treatment may also pertain to the ability of the other user's presence to affect the operation of the various set-top boxes configured throughout the premise based on the other user's movement, including the activation or deactivation of set-top boxes, pausing or playing of the DVR, etc.

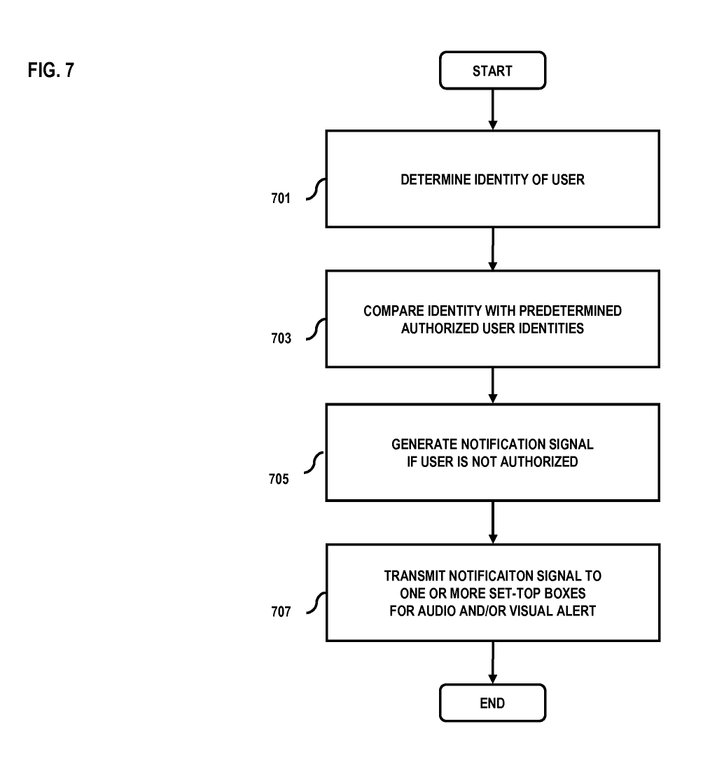

FIG. 7 is a flowchart of a process for detecting a profile of a user for controlling presentment of content to a content processing device (e.g., set-top box), according to an exemplary embodiment. For the purpose of illustration, the processes are described with respect to FIG. 1. It is noted that the steps of the processes may be performed in any suitable order, as well as combined or separated in any suitable manner. In steps 701 and 703 respectively, the identity of a user is determined and compared with one or more predetermined authorized user identities, i.e., as established by the user profiles 111 maintained by the seamless viewing platform 101. As mentioned previously, authorized users are able to interact with the seamless viewing platform 101 and hence the various set-top boxes, DVR(s), etc. of the premise based on a registered user profile 111. Also, as mentioned, the user is identified through their association with a PUI, which itself is configured to transmit data corresponding to information contained in the user profile 111. However, when the comparison of step 703 indicates the user has no established profile, the seamless viewing platform generates a notification signal indicating the user is not authorized, per step 705. Also, in step 707, the seamless viewing platform 101 transmits a notification signal to the one or more set-top boxes to generate an audio and/or visual alert. By way of example, when the user enters a region of the premise with a cell phone other than that which is registered and assigned as a PUI, there is no inherent profile match and hence the notification or audio/visual alert is generated. As mentioned previously, the user may proceed by establishing a user profile (e.g., a guest profile) assuming they are given the proper access or permissions as rendered to them by an owner of the premise, the set-top boxes, DVR or any other authorized user.

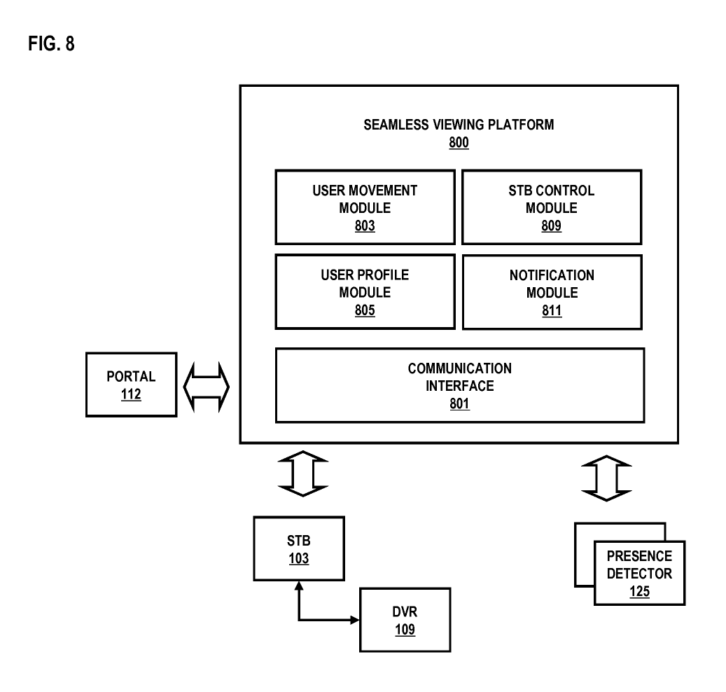

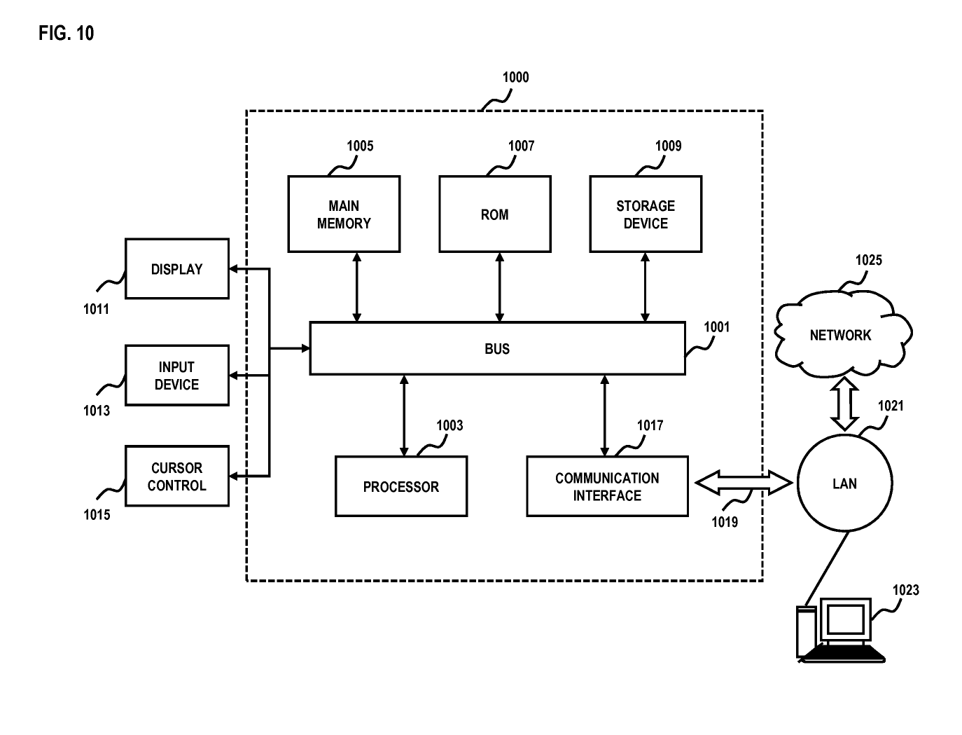

FIG. 8 is a diagram of a seamless viewing platform for managing operations of a DVR and set-top boxes within a premise, according to an exemplary embodiment. The seamless viewing platform (or platform) 800 may comprise computing hardware (such as described with respect to FIG. 10), as well as include one or more components configured to execute the processes described herein for presenting content seamlessly using a digital video recorder. In one implementation, platform 800 includes communication interface 801, user movement module 803, user profile module 805, set-top box control module 809 and notification module 811. Communication interface 801 provides connectivity to one or more content processing devices or DVRs within a single premise or across multiple premises. This interface 801 can also communicate with various service provider systems 105. In addition, the communication interface module 801 can also support communication with a portal 112, which enables users to access platform 800 via, e.g., browser applications, user customized graphical user interface (GUI) 101a.

As shown, seamless viewing platform 800 provides a user movement module 803 that interprets the feedback data as provided to it by one or more sensors of a presence detector 125. By way of example, the user movement module 803 interprets received sensor data to determine whether the user is present, has moved, changed positions, etc. within a premise. Still further, the movement module may identify and interpret signals transmitted by a device configured by a user as PUI. The one or more sensors employed by the presence detector 125 for providing sense data may be optionally configured through the seamless viewing platform 800—through execution of the user movement module 803 as well. This option is best suited for instances where the sensors of presence detector 125 are electrically coupled to the set-top box 103 or DVR 109. Under this scenario, the user customized GUI 101a (e.g., presented through the portal 112) enables the user to interact with the user movement module 803 to adjust sensor settings associated with the presence detector such as sensitivity, positioning or range.

As shown, seamless viewing platform 800 also enables a user profile module 805 for allowing users to establish their profile and configure their customized GUI. The user profile module 805 can present the user with a virtual keyboard for accepting profile data or alternatively, the user may operate a keyboard or other data entry device. The user profile module 805 may also enable the importing of profile data from other systems or devices. By way of example, the user profile module 805 parses or extracts any entered or retrieved data for populating a data record representative of the user profile 111 for an individual user. The user profile 111 is further linked to or associated with the user's personal user interface as facilitated via portal 112.

The seamless viewing platform 800 also enables a set-top box (STB) control module 809 for generating various control signals and messages for affecting the behavior of a set-top box 103 and DVR 109. The control signals are generated by the STB control module 809 based on the movement or presence of the user, as determined by the user movement module 803. Exemplary control signals produced by the module 809 for affecting STB operations include:
Pausing of content—i.e., in response to the detected presence or movement of a user
Recording of content—i.e., in response to the departure of a user from a particular room of a premise
Playing of content—i.e., in response to the entrance of a user into a particular room of a premise
Display of content—i.e., in response to an overlap period
Activation of the set-top box—i.e., in response to an elapsed overlap period
Deactivation of the set-top box—i.e., in response to an elapsed overlap period

In certain embodiments, it is contemplated that additional movements may be programmed for recognition by the user movement module 803 for further enhancing the user's degree of interaction and control over STBs 103 and DVRs 109. For example, a backwards moving motion of the user may be detected for enabling rewinding of content to a prior point in the broadcast.

The notification module 811, in one embodiment, operates in connection with the communication interface to present notifications to a user involving their interaction with the set-top box 103, DVR 109, etc. For example, when no user profile match is detected as in step 705 of FIG. 7, the notification module 811 may generate a message to indicate this to the user. In addition, the notification module may indicate update requests, error control messages or other messages pertinent to the user experience.

While specific reference will be made to this particular implementation, it is also contemplated that platform 800 may embody many forms and include multiple and/or alternative components. For example, it is contemplated that the components of platform 800 may be combined, located in separate structures, and/or separate locations. That is, platform 800 may be implemented as cloud-based servers.

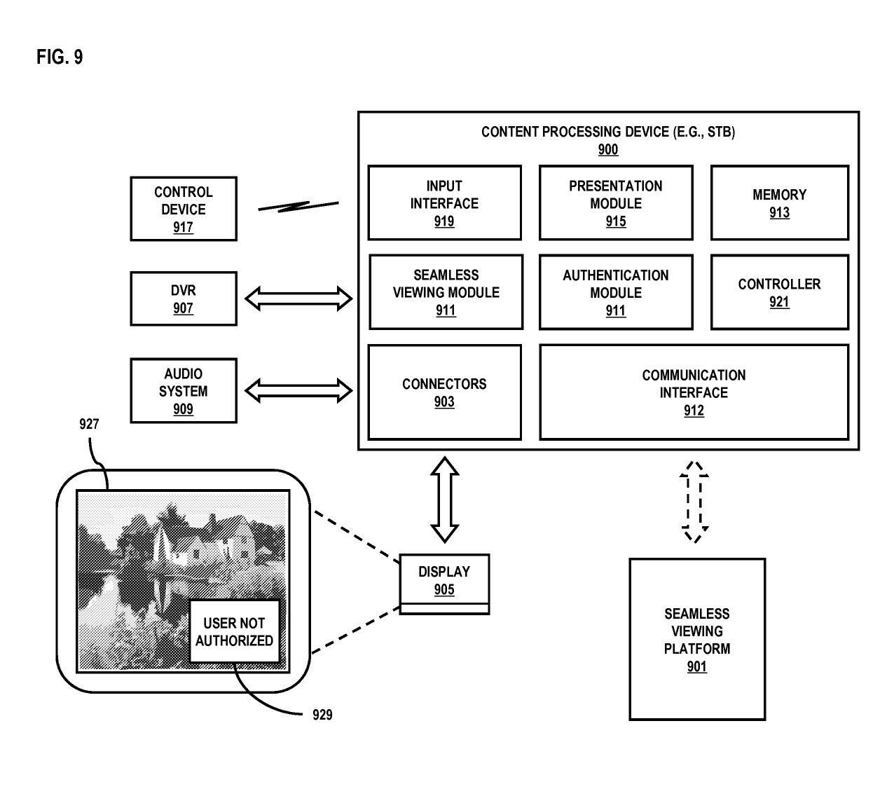

FIG. 9 is a diagram of a content processing device configured to operate with the seamless viewing platform of FIG. 1, according to an exemplary embodiment. Content processing device (or device) 900 may comprise any suitable technology to receive one or more content streams from a media source, such as MSP 119 and one or more third-party content provider systems 121. The content streams include media content retrieved over one or more data networks (e.g., networks 105 and/or 107), in response to commands from one or more media applications.

According to various embodiments, device 900 may also include inputs/outputs (e.g., connectors 903) to display 905 and DVR 907, as well as to audio system 909. In particular, audio system 909 may comprise a conventional audio-video receiver capable of monaural or stereo sound, as well as multichannel surround sound. Audio system 909 may include speakers, ear buds, headphones, or any other suitable component configured for personal or public dissemination. As such, content processing device 900, display 905, DVR 907, and audio system 909, for example, may support high resolution audio and/or video streams, such as high definition television (HDTV) or digital theater systems high definition (DTS-HD) audio. Thus, content processing device 900 may be configured to encapsulate data into a proper format with required credentials before transmitting onto one or more of the networks of FIG. 1 and de-encapsulate incoming traffic to dispatch data to display 905 and/or audio system 909. In addition, the content processing device may permit the embedding or overlay of messages 929 atop content 927 rendered to the display 905, including messages generated by the notification module 811 of the seamless viewing platform 901

In an exemplary embodiment, display 905 and/or audio system 909 may be configured with internet protocol (IP) capability (i.e., includes an IP stack, or is otherwise network addressable), such that the functions of content processing device 900 may be assumed by display 905 and/or audio system 909. In this manner, an IP ready, HDTV display or DTS-HD audio system may be directly connected to one or more service provider networks 105 and/or communication networks 107. Although content processing device 900, display 905, DVR 907, and audio system 909 are shown separately, it is contemplated that these components may be integrated into a single component, or other combination of components.

An authentication module 911 may be provided by content processing device 900 to initiate or respond to authentication schemes of, for instance, service provider network 105, third-party content provider systems 121, or various other content providers, e.g., television broadcast systems 123, etc. Authentication module 911 may provide sufficient authentication information, e.g., a user name and password, a key access number, a unique machine identifier (e.g., MAC address), and the like, as well as combinations thereof, to a corresponding communications (or network) interface 912 for establishing connectivity, via LAN 117, and to seamless viewing platform 901. Authentication at content processing device 900 may identify and authenticate a second device (e.g., computing device 115) communicatively coupled to, or associated with, content processing device 900, or vice versa. Further, authentication information may be stored locally at memory 913, in a repository (not shown) connected to content processing device 900, or at a remote repository (e.g., user profile repository 111).

Authentication module 911 may also facilitate the reception of data from single or disparate sources. For instance, content processing device 900 may receive broadcast video from a first source (e.g., MSP 119), signals from a media application at second source (e.g., computing device 115), and a media content stream from a third source accessible over communication networks 107 (e.g., third-party content provider system 121). As such, display 905 may present the broadcast video, media application, and media content stream to the user, wherein content processing device 900 (in conjunction with one or more media applications) can permit users to experience various sources of media content traditionally limited to the data domains. This presentation may be experienced separately, concurrently, in a toggled fashion, or with zooming, maximizing, minimizing, or trick capabilities, or equivalent mode. In other exemplary embodiments, authentication module 911 can authenticate a user to allow them to interact with one or more third-party subscriber account features associated with third-party content provider systems 121.

Seamless viewing module 911 may be configured to establish a customized graphical user interface (GUI) for enabling user operation and access to the seamless viewing platform 901 based on the presence and movement of a user. The seamless viewing module 911 maintains details as specified in the user profile 111 for enabling a customized viewing and device control experience. It is noted that the seamless viewing module 911 may also present various customization features for allowing users to tailor the user interface to their liking (e.g., skin selection, button activation/deactivation, text features, etc.)

Presentation module 915 may be configured to receive media content streams (e.g., audio/video feed(s) including media content retrieved over a data network) and output a result via one or more connectors 903 to display 905 and/or audio system 909. In this manner, presentation module 915 may also provide a user interface for a media application via display 905. Aural aspects of media applications may be presented via audio system 909 and/or display 905. In certain embodiments, media applications, such as media manager 901, may be overlaid on the video content output 907 of display 905 via presentation module 915. The media content streams may include content received in response to user input specifying media content that is accessible by way of one or more third party content provider systems 105 and, thereby, available over at least one data network (e.g., network 105 and/or 107), wherein the media content may be retrieved and streamed by content processing device 900 for presentation via display 905 and/or audio system 909. Accordingly, presentation module 915 may be configured to provide lists of search results and/or identifiers to users for selection of media content to be experienced. Exemplary search results and/or identifiers may include graphical elements, channels, aural notices, or any other signifier, such as a uniform resource locator (URL), phone number, serial number, registration number, MAC address, code, etc.

Connector(s) 903 may provide various physical interfaces to display 905, audio system 909, as well as other peripherals; the physical interfaces may include, for example, RJ45, RJ11, high definition multimedia interface (HDMI), optical, coax, FireWire, wireless, and universal serial bus (USB), or any other suitable connector. The presentation module 915 may also interact with control device 917 for determining particular media content that a user desires to experience. In an exemplary embodiment, control device 917 may comprise a remote control (or other access device having control capability (e.g., computing device 115), a wireless user device, mobile phone, etc.) that provides users with the ability to readily manipulate and dynamically modify parameters affecting the media content being viewed. In other examples, content processing device 900 may be configured for voice recognition such that content processing device 900 may be controlled with spoken utterances.

In this manner, control device 917 may include (not shown) a cursor controller, trackball, touch screen, touch pad, keyboard, and/or a key pad for activating a media application, navigating through broadcast channels, search results, and/or media content identifiers, as well as performing other control functions. For instance, control device 917 may be utilized to maximize a media application, navigate through displayable interfaces, locate/specify/retrieve media content, modify content processing device 900 parameters, or toggle through broadcast channels and/or media content identifiers. Control device 917 may also include functional actuators (e.g., buttons, keys, icons, etc.), such as power on/of, play, pause, stop, fast-forward, reverse, volume up/down, channel up/down, menu, ok/enter, record, info, my content, search, edit, or exit, as well as any other suitable control trigger, such as alphanumeric buttons, shift, control, back, symbols, and the like.

Further, control device 917 may comprise a memory (not illustrated) for storing preferences affecting media content viewed, which can be conveyed to content processing device 900 through an input interface 919. Input interface 919 may support any type of wired and/or wireless link, e.g., infrared, radio frequency (RF), BLUETOOTH, and the like. Thus, control device 917 may store user preferences with respect to media content, such as favorite sources, etc. Alternatively, user preferences may be tracked, recorded, or stored at content processing device 900 or at a network user profile repository 111. The preferences may be automatically retrieved and activated by a user at any time. It is noted that control device 917 may be separate from content processing device 900 or may be integrated within content processing device 900, in which case certain input interface hardware and/or software may be superfluous.

Particular embodiments enable users, via control device 917, to populate or otherwise configure a user profile. For instance, a user profile application may be provided or accessed by content processing device 900 to enable users to populate a plurality of entry fields with user information. A user profile may include one or more customized or personalized settings that affect any aspect of media content accessible via content processing device 900. More specifically, the profile may include: subscription information (account number, user name, password, avatar, moniker, etc.), subscriber demographics (age, gender, ethnicity, location of residence, zip code, school district, community, socioeconomic status, religion, marital status, ownerships, languages, mobility, life cycles, etc.), group/organizational affiliations (e.g., political), memberships, interests, buddies, friends, cohorts, system configurations, policies, associated users/devices, etc., as well as any other like personal information. Additionally, a user profile may include a “whitelist” specifying one or more accessible media content sources/subjects, a “blacklist” specifying one or more media content sources/subjects, as well as other equivalent customized settings, such as color schemes, sound effects, etc.

In other embodiments, the user profile may be established using the additional access devices described earlier (e.g., computing device 115, etc.). As such, user profile information may be stored at content processing device 900, e.g., at memory 913, and/or at a user site repository (not illustrated) directly connected to content processing device 900. Additionally or alternatively, profile information may be stored in a network-based repository (e.g., remote user profile repository 111), control device 917, and/or any other storage medium. Similarly, content processing device 900 (via memory 913), a user site repository, and/or a network-based repository may store a collection of digital audio, video and/or image content accumulated by a user. This collection may also include a plurality of identifiers, links, search results, or bookmarks to media content accessible over one or more communication networks 107, wherein selection of a particular identifier, link, search result, or bookmark may cause one or more media applications to obtain the content from an associated link (either directly from a data network source (e.g., content repository (not shown)) or indirectly from third-party content provider system 121 and/or MSP 119).

It is noted that the exemplary methods and systems presented in various embodiments enable a means of consistent, uninterrupted content viewing by users throughout a premise, particularly in response to their detected movement about the premise. In addition, the techniques presented extend to content processing devices outside of the immediate premise, including for enabling the seamless viewing of content to a wireless communication device in response to the detected movement of a user. An advantage to the user as afforded by the approach presented is that content processing devices may be automatically controlled to present content at the point at which it left off when last viewed on different content processing device by a user. As another advantage, motion detection may be employed for triggering the set-top box, including activating, deactivating it or the DVR in response to the presence of the user or lack thereof. As yet another advantage, the seamless viewing platform can act as a theft deterrent, triggering the activation of a set-top box in response to the detected motion of an intruder. By way of example, a possible intruder that does not respond to a message from the notification module 811 specifying their profile cannot be detected, may cause the set-top box to create an ambient audio sense throughout the premise, signal a security alarm, etc.

The processes described herein for presenting content seamlessly using a digital video recorder may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 10 illustrates computing hardware (e.g., computer system) 1000 upon which an embodiment according to the invention can be implemented. The computer system 1000 includes a bus 1001 or other communication mechanism for communicating information and a processor 1003 coupled to the bus 1001 for processing information. The computer system 1000 also includes main memory 1005, such as a random access memory (RAM) or other dynamic storage device, coupled to the bus 1001 for storing information and instructions to be executed by the processor 1003. Main memory 1005 can also be used for storing temporary variables or other intermediate information during execution of instructions by the processor 1003. The computer system 1000 may further include a read only memory (ROM) 1007 or other static storage device coupled to the bus 1001 for storing static information and instructions for the processor 1003. A storage device 1009, such as a magnetic disk or optical disk, is coupled to the bus 1001 for persistently storing information and instructions.

The computer system 1000 may be coupled via the bus 1001 to a display 1011, such as a cathode ray tube (CRT), liquid crystal display, active matrix display, or plasma display, for displaying information to a computer user. An input device 1013, such as a keyboard including alphanumeric and other keys, is coupled to the bus 1001 for communicating information and command selections to the processor 1003. Another type of user input device is a cursor control 1015, such as a mouse, a trackball, or cursor direction keys, for communicating direction information and command selections to the processor 1003 and for controlling cursor movement on the display 1011.

According to an embodiment of the invention, the processes described herein are performed by the computer system 1000, in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multi-processing arrangement may also be employed to execute the instructions contained in main memory 1005. In alternative embodiments, hard-wired circuitry may be used in place of or in combination with software instructions to implement the embodiment of the invention. Thus, embodiments of the invention are not limited to any specific combination of hardware circuitry and software.

The computer system 1000 also includes a communication interface 1017 coupled to bus 1001. The communication interface 1017 provides a two-way data communication coupling to a network link 1019 connected to a local network 1021. For example, the communication interface 1017 may be a digital subscriber line (DSL) card or modem, an integrated services digital network (ISDN) card, a cable modem, a telephone modem, or any other communication interface to provide a data communication connection to a corresponding type of communication line. As another example, communication interface 1017 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1017 sends and receives electrical, electromagnetic, or optical signals that carry digital data streams representing various types of information. Further, the communication interface 1017 can include peripheral interface devices, such as a Universal Serial Bus (USB) interface, a PCMCIA (Personal Computer Memory Card International Association) interface, etc. Although a single communication interface 1017 is depicted in FIG. 10, multiple communication interfaces can also be employed.

The network link 1019 typically provides data communication through one or more networks to other data devices. For example, the network link 1019 may provide a connection through local network 1021 to a host computer 1023, which has connectivity to a network 1025 (e.g. a wide area network (WAN) or the global packet data communication network now commonly referred to as the “Internet”) or to data equipment operated by a service provider. The local network 1021 and the network 1025 both use electrical, electromagnetic, or optical signals to convey information and instructions. The signals through the various networks and the signals on the network link 1019 and through the communication interface 1017, which communicate digital data with the computer system 1000, are exemplary forms of carrier waves bearing the information and instructions.

The computer system 1000 can send messages and receive data, including program code, through the network(s), the network link 1019, and the communication interface 1017. In the Internet example, a server (not shown) might transmit requested code belonging to an application program for implementing an embodiment of the invention through the network 1025, the local network 1021 and the communication interface 1017. The processor 1003 may execute the transmitted code while being received and/or store the code in the storage device 1009, or other non-volatile storage for later execution. In this manner, the computer system 1000 may obtain application code in the form of a carrier wave.

The term “computer-readable medium” as used herein refers to any medium that participates in providing instructions to the processor 1003 for execution. Such a medium may take many forms, including but not limited to computer-readable storage media ((or non-transitory media)—i.e., non-volatile media and volatile media), and transmission media. Non-volatile media include, for example, optical or magnetic disks, such as the storage device 1009. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

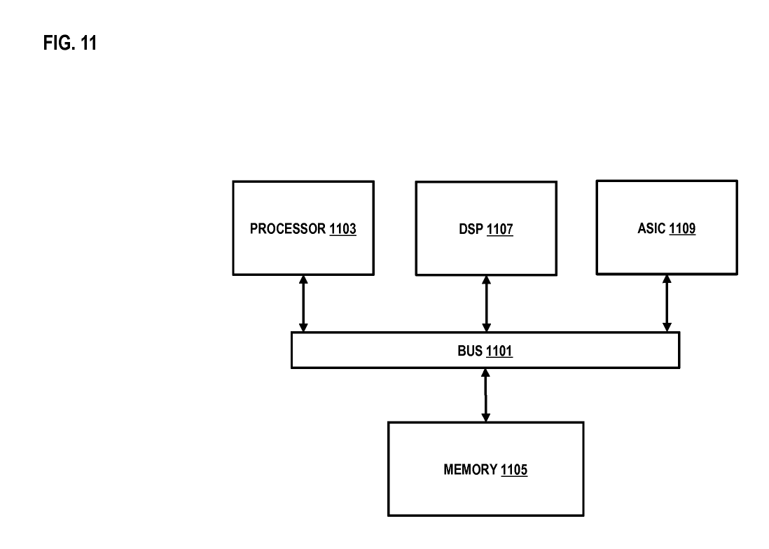

FIG. 11 illustrates a chip set 1100 upon which an embodiment of the invention may be implemented. Chip set 1100 is programmed to present a slideshow as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1100, or a portion thereof, constitutes a means for performing one or more steps of FIGS. 2, 3, and 7-9.

In one embodiment, the chip set 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1105 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
presenting content, by one of a plurality of set-top boxes, to a display for viewing by a user, wherein the plurality of set-top boxes are situated within a plurality of regions of a premise, the one set-top box being situated within one of the regions;
pausing the presentation of the content in response to detection of movement of the user to another region of the premise; and
entering an inactive state by the set-top box upon determining that another one of the set-top boxes is resuming the presentation of the content, wherein the other one of the set-top box corresponds to the other region.

2. A method according to claim 1, further comprising:
communicating via a user interface configured to sense motion of the user to determine the presence of the user in the one region or to detect the movement to the user into the other region.

3. A method according to claim 2, wherein the user interface is further configured to receive a signal from a locator device affixed to the user, wherein the signal is used to determine the region in which the user occupies.

4. A method according to claim 1, wherein presence of another user within the one region is determined, the further comprising:
retrieving a profile of either the user or the other user to determine treatment of the content based on the presence of the other user.

5. A method according to claim 1, wherein the second control message specifies presentation of the content at the other set-top box according to an overlap period, and the one set-top box is deactivated upon expiration of the overlap period, the overlap period representing a time period during which the one set-top box and the other set-top box are concurrently presenting the content.

6. A method according to claim 1, further comprising:
receiving a notification signal indicating that the user is not authorized to be present within the premise, the notification signal including either an audio alert signal, a visual alert signal, or a combination thereof

7. A method according to claim 1, further comprising:
initiating storage of the content at a network personal video recorder; and
initiating transfer of information regarding the content and a profile of the user to a mobile device in response to detection of the user leaving the premise, the mobile device receiving the content from the network personal video recorder according to the content information and the profile.

8. An apparatus comprising:
at least one processor; and
at least one memory including computer program code for one or more programs,
the at least one memory and the computer program code configured to, with the at least one processor, cause the apparatus to perform at least the following,
present content, by one of a plurality of set-top boxes, to a display for viewing by a user, wherein the plurality of set-top boxes are situated within a plurality of regions of a premise, the one set-top box being situated within one of the regions,
pause the presentation of the content in response to detection of movement of the user to another region of the premise, and
enter an inactive state by the set-top box upon determining that another one of the set-top boxes is resuming the presentation of the content, wherein the other one of the set-top box corresponds to the other region.

9. An apparatus according to claim 8, wherein the apparatus is further caused to:
communicate via a user interface configured to sense motion of the user to determine the presence of the user in the one region or to detect the movement to the user into the other region.

10. An apparatus according to claim 9, wherein the user interface is further configured to receive a signal from a locator device affixed to the user, wherein the signal is used to determine the region in which the user occupies.

11. An apparatus according to claim 8, wherein presence of another user within the one region is determined, the further comprising:
retrieving a profile of either the user or the other user to determine treatment of the content based on the presence of the other user.

12. An apparatus according to claim 8, wherein the second control message specifies presentation of the content at the other set-top box according to an overlap period, and the one set-top box is deactivated upon expiration of the overlap period, the overlap period representing a time period during which the one set-top box and the other set-top box are concurrently presenting the content.

13. An apparatus according to claim 8, wherein the apparatus is further caused to:
receive a notification signal indicating that the user is not authorized to be present within the premise, the notification signal including either an audio alert signal, a visual alert signal, or a combination thereof

14. An apparatus according to claim 8, wherein the apparatus is further caused to:
initiate storage of the content at a network personal video recorder; and
initiate transfer of information regarding the content and a profile of the user to a mobile device in response to detection of the user leaving the premise, the mobile device receiving the content from the network personal video recorder according to the content information and the profile.

15. A method comprising:
determining presence of a user within one region of a plurality of regions within a premise, wherein the regions have correspondingly a plurality of set-top boxes, wherein the user is presented with content by one of the set-top boxes corresponding to the one region;
detecting movement of the user from the one region to another region of the premise based on the determined presence;
generating a first control message instructing the one set-top box to pause the presentation of the content in response to the detection of the movement; and
generating a second control message instructing another one of the set-top boxes to resume the presentation of the content, wherein the other set-top box corresponds to the other region.

16. A method according to claim 15, further comprising:
sensing motion of the user to determine the presence of the user in the one region or to detect the movement to the user into the other region.

17. A method according to claim 15, further comprising:
receiving a signal from a locator device affixed to the user, wherein the signal is used to determine the region in which the user occupies.

18. A method according to claim 15, further comprising:
determining presence of another user within the one region; and
retrieving a profile of either the user or the other user to determine treatment of the content based on the presence of the other user.

19. A method according to claim 15, further comprising:
determining an overlap period during which the one set-top box and the other set-top box are concurrently presenting the content,
wherein the second control message specifies presentation of the content at the other set-top box according to the determined overlap period, and the one set-top box is deactivated upon expiration of the overlap period.

20. A method according to claim 15, further comprising:
determining whether the user is authorized to be present within the one region of the premise; and
generating a notification signal indicating that the user is not authorized, wherein the notification signal is presented via anyone of the set-top boxes, the notification signal including either an audio alert signal, a visual alert signal, or a combination thereof.

21. A method according to claim 15, wherein the content is stored within a network personal video recorder, the method further comprising:
detecting the user leaving the premise; and
initiating transfer of information regarding the content and a profile of the user to a mobile device in response to the detection of the user leaving the premise, the mobile device receiving the content from the network personal video recorder according to the content information and the profile.
